(19) United States
(12) Patent Application Publication
(10) Pub. No.: US 2022/0182346 A1
(43) Pub. Date: Jun. 9, 2022

(54) SYSTEMS AND METHODS FOR REVIEW AND RESPONSE TO SOCIAL MEDIA POSTINGS

(71) Applicant: Tru Review LLC, Cherry Hill, NJ (US)

(72) Inventors: Garrett M. Yarnall, Scotch Plains, NJ (US); Michael Sciore, Cherry Hill, NJ (US)

(21) Appl. No.: 17/457,563

(22) Filed: Dec. 3, 2021

Related U.S. Application Data
(60) Provisional application No. 63/199,042, filed on Dec. 3, 2020.

(51) Int. Cl. H04L 51/00; H04L 51/52; G06Q 50/00

(52) U.S. Cl. CPC H04L 51/12; H04L 63/08; G06Q 50/01; H04L 51/32

(57) ABSTRACT

A system and method are disclosed that enable the evaluation of comments posted on a Web site and recommended actions to take in view of the evaluation results. Standards taken from one or more Web sites and other standards are copied to a server system including a database. A post is compared to the standards to identify any violations of standards. If evaluation results indicate that the post violates at least one standard or it triggers a different aspect of evaluation, a communication can be sent to a target of the post, such as a business. The communication can include a graphical representation of evaluation results, a copy of at least part of the post, and a recommended action to take in view of the evaluation results.

### CROSS-REFERENCE TO RELATED APPLICATIONS

This application claims the benefit of U.S. Provisional Patent Application No. 63/199,042 filed on Dec. 3, 2020, with the United States Patent and Trademark Office, the contents of which are incorporated herein by reference in their entirety.

### FIELD OF INVENTION

The present invention is generally related to evaluating comments that are publicly posted on a Web site and scoring the evaluated comments, and particularly to verifying the authenticity of such comments, confirming accuracy of statements therein, and their adherence to terms of use, guidelines, and other standards associated with the Web site on which the comments are posted among other standards.

### BACKGROUND OF THE INVENTION

The Internet has made it possible to for individuals to share vast amounts of information with great ease. Indeed, one of the stated purposes of the Internet at its inception was to “give universal access to a large universe of documents.” Today, Internet users share a wide variety of items from research papers to videos to news articles, etc. However, there remains a dearth of solutions which help to identify and verify accuracy of a post or adherence to the relevant terms or use or guidelines on the Web site on which comments are posted.

Among the many things Internet users may now share online are subjective opinions. Users frequently post reviews on Web sites detailing products they purchase, television programs they watch, or sporting events. A large industry has also emerged for people to post reviews of their experiences with services from a variety of businesses. Reviews may be shared on social media platforms such as Facebook and Twitter or on dedicated business review Web sites such as Yelp, Angie's List, and TripAdvisor. As an example, by the end of September 2018, Yelp reported the publication of over 171 million user reviews.

With such a large volume of reviews in existence, a concern for businesses is the public image resulting from such reviews. While positive reviews build the reputation of a business, negative reviews are potentially extremely damaging to a business. This is especially concerning when posts include information that is questionably true or simply out right fiction. Internet users frequently visit review Web sites prior to using the services of a business in order to evaluate the quality and service of the business and a negative review can easily cause a prospective new customer to decide against using a particular business. As such, the authenticity and truthfulness of such reviews is crucial to the success of a business. Negative reviews posted falsely can and do cause irreparable harm but are often difficult to detect and have removed from review Web sites.

Similarly, the modern “24-hour news cycle” includes posts which are purported to be factual in nature or are targeted at hot button issues which appear to be newsworthy, each of which are easily conflated with opinion posts, or where the “facts” provided in a post are intentionally or unintentionally false or misleading. This leads to spread of misinformation and even worse, to people generally questioning facts as if they were opinion. However, these posts come from all varieties of accounts, including those which are obviously fake accounts, to those which are obviously real. However, these posts lead to real damage to businesses and individuals who are targeted by this modern news paradigm.

Applicant has identified a new methodology and systems to manage and review online postings for indicia of authenticity or to validate and confirm their truthfulness in an unbiased manner, and, in certain applications, where actions are instituted to remove posts which are deemed to be in violation of the terms of service or other protocols of the agreement with users of the Web site, either automatically or through further checks and balances.

### SUMMARY OF THE INVENTION

In a preferred embodiment, a system for evaluating a post of interest found on a Web site comprising: (a) a computer having a processor and a memory; (b) a database operatively connected to the computer, the database containing subscriber information and search terms relating to standards from the Web site; and (c) wherein the memory of the computer stores executable code which, when executed, enables the computer to perform a process comprising the following steps: (i) process the post of interest against the search terms, the post of interest obtained from the Web site and relating to a subscriber; (ii) mark content in the post of interest that corresponds to matched search terms, the marked content indicative of a violation of at least one Web site standard; and (iii) based on a result of the marking, recommend a solution to resolve the violation of the at least one Web site standard.

In a further embodiment, the system wherein a plurality of categories is identified from the standards for the Web site and the search terms are grouped so that each category in the plurality is associated with a corresponding group of search terms, the database containing the Web site's standards, the plurality of categories, and their corresponding group of search terms.

In a further embodiment, the system further comprising the step of updating the database to include newly identified search terms learned from the post of interest, the newly identified search terms grouped to be associated with a corresponding category in the plurality of categories.

In a further embodiment, the system further comprising the step of calculating a score for the post of interest, the score to reflect a number of standards violations for each category in the plurality of categories in which a violation was found.

In a further embodiment, the system wherein the database further contains conditions for authenticating the post of interest selected from the group consisting of: determining if a commentor photo is present in a commentor profile, determining if a commentor has posted at least one other comment on the Web site, determining if there is a positive statement in the posted comment relating to a competitor of the subscriber, determining if the commentor is using a fake name or an alias, and combinations thereof; and further comprising the step of calculating a degree to which the post of interest is authentic based on the determinations of the conditions.

In a further embodiment, the system wherein the step of marking content in the post of interest further comprises assigning a distinctive mark to each category in the plurality of categories to visually mark content in the post of interest according to category.

In a further embodiment, the system further comprising the step of enabling the subscriber to authorize acting on the recommended solution by generating a digital document that includes a selectable authorization button.

In a further embodiment, the system further comprising, in response to receiving an indication that the subscriber selected the selectable authorization button, automatically generating a communication to send to the Web site, a commentor, or both.

In a further embodiment, the system wherein automatically generating the communication further comprises identifying a particular standard from the Web site that was violated and the marked content in the post of interest that is in violation of the identified standard and requesting removal or modification of the post of interest.

In a further preferred embodiment, a method for evaluating a comment posted on a Web site comprising: (a) extracting evaluation categories and associated search terms from standards obtained from the Web site; (b) using the associated search terms to identify and mark content in the comment that corresponds with at least one evaluation category; and (c) based on identification and marking results, recommending a course of action to take to resolve an issue relating to the Web site's standards.

In a further embodiment, the method further comprising generating a correspondence for a target of the comment, the correspondence to include a color-coded icon of a face with an expression and a range of stars from zero to five, the correspondence to also include a selectable button that, if selected, causes a letter to the Web site to be generated.

In a further preferred embodiment, a method of scoring a post on a hosting Web site comprising: (a) identifying a post relating to a subscriber on the hosting Web site; (b) capturing a set of standards for the hosting Web site within a first database to construct a set of categories related to standards, each category having its own set of search terms; (c) copying the post and associated metadata into a second database; (d) grading the post against the set of categories to detect violations of the standards; and (e) circulating a report to the subscriber regarding the graded post, the report to include a recommended step forward based on the graded post results.

In a further embodiment, the method wherein grading against the set of categories comprises comparing the post to the set of search terms for each category and annotating the post to visually identify each of the violations wherein a violation of one category is marked with a different identifier than a violation of a different category.

In a further embodiment, the method further comprising the step of: (f) sending a periodic report to the hosting Web site, the periodic report to identify for removal one or more new posts that violate a standard since a last periodic report and to notify the hosting Web site of any updates regarding posts identified for removal in a previously sent report.

In a further embodiment, the method further comprising the steps of: (g) constructing a set of criteria based on the captured set of standards, the set of criteria related to positive or negative language, authenticity, or both, each criteria having its own set of search terms, identifier other than a search term, or both; and (h) grading the post against at least one criterion in the set of criteria.

In a further embodiment, the method wherein grading the post against at least one criterion further comprises using an algorithm to grade the post for authenticity, the algorithm to provide a probability relating to the authenticity of the post.

In a further embodiment, the method further comprising the step of: (i) grading the post for removal from the hosting Web site or for modification; and recommending communicating with the hosting Web site, the commentor, or both.

In a further embodiment, the method wherein each grading step comprises a score of between 0 and 10, and wherein a score of more than 0 indicates that the post violates of at least one category or criteria.

In a further preferred embodiment, a method of determining accuracy of posted comments comprising the steps of: (a) copying posted comments to a database; (b) populating the database with standards relating to a location in which the posted comments were posted; (c) identifying violations of the standards by comparing the posted comments to the standards; and (d) annotating the violations to identify content in the posted comments by a particular standard of which the content is in violation.

In a further embodiment, the method wherein the annotating step (d) comprises highlighting content in different colors to correlate violative content to the particular standard of which the content is in violation.

In a further embodiment, the method wherein in step (b), the location is a hosting Web site, and wherein the standards comprise (i) terms of service or policies of the hosting Web site and (ii) laws and regulations based on the location of an IP address corresponding to the location of a commentor or of the hosting Web site.

In a further embodiment, the method further comprising the step of: (e) sending a report to an e-mail address listed on the hosting Web site for violations of the hosting Web site's terms of service, policies, or both. In a further embodiment, the method wherein posted comments are selected from the group consisting of: text, video, a GIF, an image, and combinations thereof.

### BRIEF DESCRIPTION OF THE FIGURES

FIG. 1 details an embodiment of an evaluation and reporting system.

FIG. 2 details a flowchart of an embodiment of a process for evaluating a post of interest.

FIG. 3 details a flowchart of an embodiment for authenticating a post of interest.

FIG. 4 details a flowchart of an embodiment for grading/scoring a post of interest.

FIG. 5 details a flowchart of an embodiment for acting on an evaluated post of interest.

FIG. 6 details an exemplar interface for gathering/displaying information relating to the post of interest.

FIG. 7 details an exemplar interface for gathering/displaying information relating to an evaluation category.

FIG. 8A details an exemplar interface for a post of interest that has been evaluated and FIG. 8B continues the details of the exemplar interface of FIG. 8A.

FIG. 9 details an exemplar e-mail generated in response to the evaluation of the post of interest.

### DETAILED DESCRIPTION OF THE INVENTION

Before the advent of the Internet, people wrote letters to businesses, associations, organizations, etc. to let them know if they were pleased or displeased about their experience, service, product, or the like. Alternatively, one could leave feedback in a suggestion box, on a receipt, via a tip or the like. Similarly, people used (and still use) word-of-mouth to recommend a business, or to deter others from using the businesses. Most of these interactions were between just a few people and probably did not have widespread ramifications unless the business was hugely popular or unpopular in a community. Furthermore, with word-of-mouth, the credibility of the person can be taken into consideration when evaluating the accolades or condemnations, especially if the person is known, or the communication is face-to-face.

Although some people may still write letters, leave notes, spread rumors, etc., it is ever more likely that a person may post comments on a Web site such as a review platform, social media platform, service-based platform, blog, wiki, to name a few examples. And Internet users are more likely to turn to posted comments to gather information about a person, place, or thing before investing time and/or money. While many posted comments are truthful and helpful, some are most certainly not. Information gathers have no idea if the posts are based on real experiences by real people, or if they are made up. Unlike face-to-face interactions, comments posted on a Web site may be difficult to rely on since the source of the information can be suspect. Furthermore, targets of malicious, inaccurate, or otherwise harmful comments/content may find it difficult to find time and/or resources to help them monitor their online presence and to try to fix wrongs. Similarly, targets of unsolicited compliments, honest reviews, or the like may want to acknowledge that the post has been independently verified and express their gratitude whether it be via a reply post or something more, or both.

Systems and methods are disclosed herein to improve the evaluation of comments posted by a commentor on a Web site. The systems and methods streamline the evaluation process by searching one or more Web sites (i.e., a presence on the World Wide Web) for posts that are of interest. A post (e.g., content uploaded to a Web site regardless of format such as a review, news, or the like directed toward a business, product, person, etc.) may be of interest for several reasons including, without limitation, having positive statements and/or negative statements, being suspected of violating a Web site's conditions for use of its services, being suspected of not being authentic, among others. The systems and methods may be used to identify, within the post, positive comments, selected problems, or both. Furthermore, systems and methods may also correlate selected problems found in the post with the Web site's standards that are believed to be in violation.

In an embodiment, the post may be graded, receive a score, or both. As one example, the number and type of standards violations found in a post may be counted and summed, weighted, or both. Other examples of grading/scoring include expressing results as percentages/percent confidences, ratios, ratings, placement on a continuum, and combinations thereof. The results of post analysis may be sent to a target (e.g., business, company, product, person to which the post is directed, etc.) of the post for its consideration. In an embodiment, results may also include one or more suggested courses of action.

Many, if not all, businesses (e.g., for-profit, not-for-profit, institutions, organizations, sole proprietorships, firms, partnerships, community groups, etc.) are concerned with their online presence. And many, if not most, businesses have their own Web site with content of their own choosing. This content is relatively easy to control since the business “owns” its Web site. When content is posted on a Web site that is owned by another entity, however, a business may not have much control (if any) over the content. This becomes an issue when the content is false, misleading, inappropriate, inauthentic, or otherwise objectionable. For this reason, Web sites often have terms of service/use (e.g., “TOS”), guidelines, policies, rules, regulations, etc. (collectively, “standards”).

Although some Web sites do a respectable job of removing content that violates its standards, many may only do so when the violation is brought to their attention. Businesses, especially small businesses, may not have the time or wherewithal to monitor content being posted about it, much less have the time or knowledge to address any important issues. For example, a welding shop having several independent metal workers/welders and the owner may be interested in knowing what customers are saying about the shop, individual workers, and/or their products. In the case of a glowing, unsolicited review of the shop or a particular worker, the worker, shop owner, or both may want to thank the commentor in some way. In the case of other reviews, the shop owner may want to know how the public perceives the shop, its workers, its products, whether good or bad, to improve the business. As another example, a restaurant may also want to express gratitude and/or understand the comments being made about it to identify where it is succeeding or failing in the eyes of the public. As yet another example, a community organization may also monitor what the online community is saying about it. The businesses in the forgoing examples may not have big advertising budgets and may rely on the possibility of “going viral” (in a positive sense) to promote their business. Thus, it is especially important to these types of businesses to feel like they have a way to make sure false claims, attacks, misinformation, etc. disseminated on a Web site can be quickly identified, addressed, and hopefully resolved.

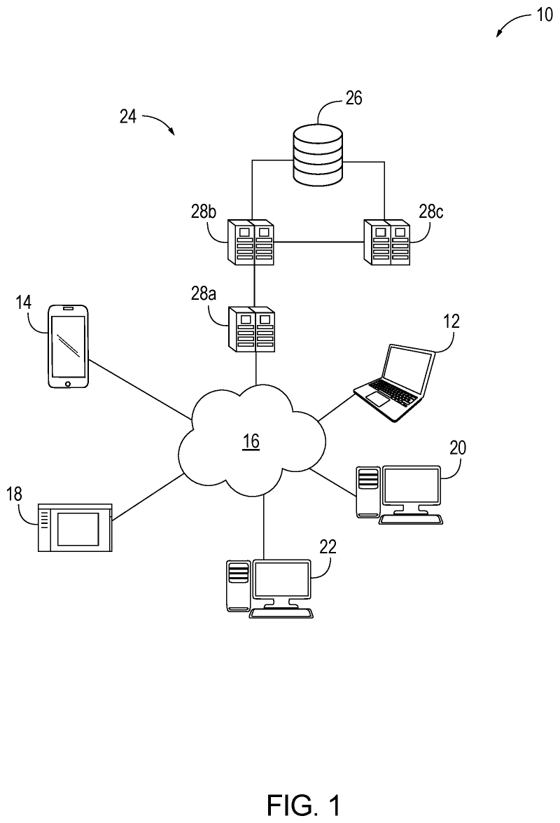

In an embodiment, a business (“subscriber”) may subscribe to a system for evaluating one or more posts relating to the subscriber made on one or more Web sites. Referring to FIG. 1, an analyst may use analyst computer (12) to access a system (10) upon which a commentor has uploaded a post regarding a target such as a subscriber. Generally, the commentor may use a device (14) to upload the post over a network (16) to a Web site (18). In addition to the commentor's device (14), a multitude of other devices, including the analyst computer (12), a subscriber computer (20), a service partner computer (22), and a server system (24) may access the Web site (18) via the network (16). In fact, the network (16) may connect all the computing devices (12, 14, 18, 20, 22, 24) as is known in the art.

The analyst may use analyst computer (12), server system (24), or both to search for one or more posts on Web site (18) that mention the subscriber, a person associated with the subscriber, a product sold by the subscriber, a service associated with the subscriber, and the like. It should be noted that although only one Web site (18) is shown in FIG. 1, a multitude of Web sites (18) are connected to network (16), such as the Internet. A search for posts relating to the subscriber may include searching any number of Web sites connected to the network (16). When the commentor's post is found, the content of the post may be evaluated for violations of various standards, positive comments, authenticity, as a few nonlimiting examples. In an embodiment, the post may be evaluated, and if further action is warranted, it may be copied to analyst computer (12), server system (24), or both. Alternatively, posts may be copied first, before being evaluated. Results of a post's evaluation may be stored in and retrieved from analyst computer (12), one or more databases associated with the server system (24) (e.g., database [26]) or both.

In an embodiment, the subscriber may use computer (20) to access the commentor's post on Web site (18) and/or a file associated with the evaluated post such as from server system (24). For example, subscribers may use a portal to access files associated with its account. Similarly, a service partner may use computer (22) to access the commentor's post on Web site (18) and/or use a portal to access files associated with the evaluated post. In an embodiment, a subscriber may use the portal to do its own search and evaluation of posts.

Server system (24) may comprise one or more servers (28a), (28b), and (28c). Server system (24) may also include one or more databases (26). Although three servers (28a), (28b), and (28c) are shown in server system (24), embodiments are not so limited. The numbers and types of servers and software may be scaled up, down, and/or distributed according to server system (24) demands/needs. Furthermore, more than one virtual machine may run on a single computer and a computer/virtual machine may run more than one type of server software (e.g., the software that performs a service, e.g., Web service, application service, and the like). Thus, in some instances server system (24) may include one computer (optionally including analyst computer [12]) for all processing demands, and in other instances server system (24) may include several, hundreds, or even more computers to meet processing demands. Additionally, hardware, software, and firmware may be included in server system (24) to increase functionality, storage, and the like as needed/desired. Web sites (18) may be implemented in a manner that is similar to server system (24), and/or as is known in the art.

Computers (12), (14), (20), and (22) may be laptop computers, desktop computers, tablets, mobile/handheld computer (e.g., phones, smartphones, tablets, personal digital assistants) and the like, which would be understood to include/be connected to a display screen, monitor, keyboard and/or other peripherals as warranted. There is nothing, however, precluding these computers from being wearables such as watches, glasses, and the like, and/or from being part of a system of computers such as server system (24).

Computers (12), (14), (20), and (22) and servers (28a), (28b), and (28c) may each be a general-purpose computer. Thus, each computer includes the appropriate hardware, firmware, and software to enable the computer to function as intended. For example, a general-purpose computer may include, without limitation, a chipset, processor, memory, storage, graphics subsystem, and applications. The chipset may provide communication among the processor, memory, storage, graphics subsystem, and applications. The processor may be any processing unit, processor, or instruction set computers or processors as is known in the art. For example, the processor may be an instruction set based computer or processor (e.g., x86 instruction set compatible processor), dual/multicore processors, dual/multicore mobile processors, or any other microprocessing or central processing unit (CPU). Likewise, the memory may be any suitable memory device such as Random Access Memory (RAM), Dynamic Random Access memory (DRAM), or Static RAM (SRAM), without limitation. The processor together with the memory may implement system and application software including instructions disclosed herein. Examples of suitable storage includes magnetic disk drives, optical disk drives, tape drives, an internal storage device, an attached storage device, flash memory, hard drives, and/or solid-state drives (SSD), although embodiments are not so limited.

In an embodiment, one or more servers (28a), (28b), and (28c) may include database server functionality to manage database (26) and/or another database. Although not expressly shown, architecture variations may allow for database (26) to have a dedicated database server machine, which may be implied by the operative connection of database (26) to server (28b) and (28c) where one of the servers (28b) and (28c) are a dedicated database server. Database (26) may be any suitable database such as hierarchical, network, relational, object-oriented, multimodal, nonrelational, self-driving, intelligent, and/or cloud based to name a few examples. Although a single database (26) is shown in FIG. 1, in embodiments database (26) may comprise more than one database that may be distributed across many locations, and data may be redundantly recorded in the more than one database. Analyst computer (12) may be associated with a database that is the same as or similar to database (26). It should be noted that architectures shown/discussed in connection with FIG. 1 are not limiting. Other implementations may be utilized as is known, or will be known in the art.

As was previously mentioned, subscribers and/or service partners may access the system (10) using a portal. This type of portal may enable the subscribers/service partners to access and use certain services associated with the system (10) such as reviewing evaluated posts, reports, documents, etc. that are connected to the subscriber/service partner. The subscriber/service partner portals may also enable communications between interested parties should the circumstances warrant.

The analyst may also access the system (10) via a portal. The analyst portal, however, may enable the analyst, or administrator, or both (collectively “analyst”) to set up a subscriber accounts; set up service partner accounts; manage categories, search terms, and other evaluation criteria, Web site standards and other standards; grading, and scoring to name just a few examples. In addition to the portals, interested parties (e.g., subscriber, analyst, service partner) may communicate via any available means such as digitally (e-mail, texting, telephone, file share, etc.) and/or analog (e.g., telephone, mail, face-to-face, and the like).

In a preferred embodiment, the analyst computer (12), subscriber computer (20), and service partner computer (22) each have a Web browser, which may be used to access its respective portal to the system (24). For example, analyst computer (12) may send a request (over network [16]) to server (28a), via its Web browser, and server (28a) may return a log in page to the analyst's computer (12), which is rendered by the Web browser. After logging in, the analyst is connected to the analyst portal and may proceed as desired. The subscriber and service partner may access their respective portals in a similar manner. Thus, in this example, server (28a) may function as a Web server or the like that receives requests from browsers and returns appropriate responses. Appropriate responses may depend on several factors such as the requesting browser, and the request itself. In an embodiment, the server (28a) may return one or more of the following in response to a browser request: a Web page, a Web-based application (e.g., browser-based or client-based), a progressive Web application, a cloud-based application, and the like. In an embodiment, Web pages including instructions for graphical user interfaces described herein may be requested by a browser such as one running on the analyst computer (12) and returned by server (28a).

Server (28a) may communicate with server (28b), which in an embodiment may function as an application server. Generally, the server (28b) may include business logic, including one or more of the processes described herein, additional logic, rules, and the like. Generally, logic may be used to process user requests, inputs, and/or any other information from the browser or the like. In embodiments, processing may also include using artificial intelligence, such as “machine learning” via neural network architectures, deep learning neural networks and the like to learn from user inputs, data processing, and/or other gathered information, without limitation. Moreover, processing may also include processing against/using information in the database (26) according to one or more processes described herein. Toward this end, server (28b) may also query a database (26) to store and/or retrieve files/records from storage either directly or via server (28c). That is, in an embodiment, server (28c) may be a dedicated database server that holds one or more databases and database management systems. In an embodiment sever (28c) may implement additional applications without limitation. Furthermore, in an embodiment, there are only two servers (28a) and (28b). Thus, the database (26) may be managed/accessed by one or both servers (28a) and (28b), as is known in the art. Although shown as a tiered architecture, in an embodiment, the general architecture described above may be implemented in a cloud computing environment such as Amazon Web Services (AWS), Microsoft Azure, or the like.

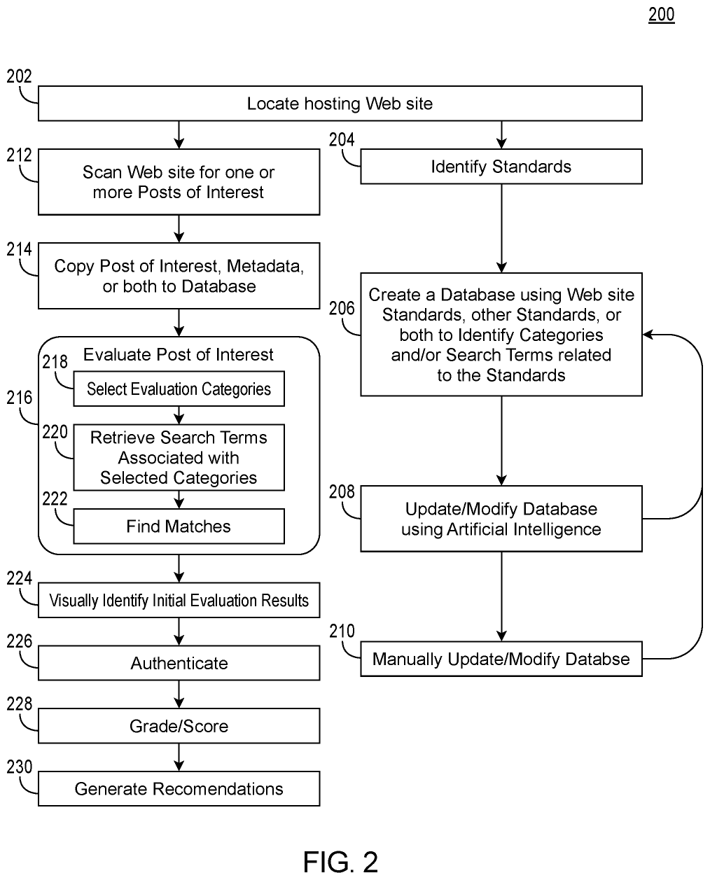

FIGS. 2-5 are flowcharts showing processes that may be implemented by system (10) to evaluate the content of a post. In an embodiment, some or all of the steps shown in the flowcharts may be implemented as a Web application, a native application, an emulated application, or the like. Notably, the steps shown in FIGS. 2-5 may be used in whole or in part. That is, some embodiments may utilize certain steps and not others and some embodiments may utilize most or all of the outlined steps. Furthermore, some or all of the steps shown in FIGS. 2-5 may be automated.

One nonlimiting example of a varied process includes: scanning a Web site for posts; processing a found post against a database of search terms for violations of the standards; annotating the post to point to causes for potential violations of the standards; flagging the post for Web site removal or other action; and providing the causes (e.g., language or other content) believed to violate the Web site standards.

Another nonlimiting example includes supplementing the forgoing process by generating a report or other communication to the target of the post. For example, if the post is about a local welding shop “Blacksmith” and Blacksmith subscribes to a service provided by an embodiment of the system and/or methods described herein, then scanning for posts and identifying a violative post about Blacksmith triggers a report regarding the violative post. In an embodiment, the report may also suggest an action to take in view of the identified violations.

In an embodiment, the system/methods described herein may also include one or more steps for grading such as grading for positive or negative language, for violations of standards, for authenticity (e.g., fake or real account or fake information presented in the post), and for removal from the Web site, for customer communication, or both.

In a preferred embodiment a varied process may include the following steps: (1) generating a list of search terms relevant to a plurality of Web sites, the search terms relating to issues regarding at least (a) authenticity of the post/profile and (b) violations of terms and service; (2) capturing a post from a Web site and storing the post within a database, (3) annotating the post against the list of search terms to identify occurrences of search terms related to at least (a) and (b); (4) creating a score for at least (a) and (b); (5) annotating the post with the score; and (6) referring the post to a network of providers to review the score and determine an appropriate action.

In another preferred embodiment a varied process may include the following steps: (a) identifying publicly posted content; (b) copying the content to a database (e.g., of server system [24]); (c) determining standards (e.g., Web site and/or other standards) regarding the physical location of the content; (d) populating the database the standards; and (e) analyzing the content by comparing the content the standards to identify content violations of the standards.

The forgoing examples are just a few examples of how various steps of the processes outlined in FIGS. 2-5 may be implemented. Many more variations are possible, and even probable. Method variations may depend on multiple factors such as the particular circumstances relating to one or more of: the Web site, post, subscriber, service partner, analyst, commentor, and the like.

Referring to the flowchart shown in FIG. 2, a method (200) may begin by locating at least one hosting Web site (202). A hosting Web site (18) may be a Web site that enables commentors to upload content/comments to its platform (i.e., post) for other network users to view. At least one such post on a hosting Web site (18) may be considered to be of interest. Evaluation and further analysis of a post may rely on data stored in database (26). Such data may be obtained from the hosting Web site (18).

Referring to step (204), on the right side of FIG. 2, standards associated with the hosting Web site (18) may be identified. Web site standards may be identified manually, such as by the analyst, by a program designed to search for Web site standards, or both. Once identified, standards may be copied, scraped or the like and uploaded (206) to the database (26). Additional information relating to the hosting Web site (18) may also be copied or scraped and uploaded to the database (26) such as a uniform resource locator (URL), a machine access control (MAC) address, an Internet Protocol (IP) address, the version of the standards that were obtained, and the date on which the version was put into effect, to name a few nonlimiting examples. In the same way (e.g., identified and copied/scraped) additional standards such as laws and regulations based on the location of an IP address or federal laws/regulations may be added to the database (26). In an embodiment, the application that searches for Web site and other standards may be stored and executed on server such as server (28b) and may be similar to a search engine.

Still referring to step (206), contents of database (26) (e.g., standards) may be subject to analytical software to determine various evaluation categories, subcategories, and associated search terms. For example, the standards may be subjected to a decision support system including various programs that can analyze data a predict outcomes. These programs may also be stored and executed on a server such as server (28b), according to an embodiment. The decision support system may include programs that analyze tags (e.g., HTML tags or the like), use one or more seed words, use text mining, and/or use natural language processing, to examine standards and identify categories, subcategories, and associated search terms. Alternatively, standards may be subjected to the forgoing tools apart from a decision support system. Either way, the standards may be used to reveal one or more ways to organize the standards (e.g., into categories, subcategories, and respective search terms), which may be used to evaluate posts for violations of the standards. In an embodiment such organization may be further optimized via artificial intelligence (e.g., machine learning via neural networks and/or deep learning) (208), human decision-making (210), or both. Thus, data stored in database (26), may also include a plurality of search terms (e.g., keywords/phrases) associated with one or more evaluation categories, subcategories, or both, which are instrumental for evaluating posts. That is, search terms relate to the standards on which evaluation categories are based. Search terms, however, are not limited to being related to the standards; the database (26) may also include search terms related to one or more risk factors that are not necessarily based on a standard, including but not limited to puffery language, exaggerations, negative language, cliché, and the like, as well as nonrisk factors such as positive statements, affirmations, compliments, and the like.

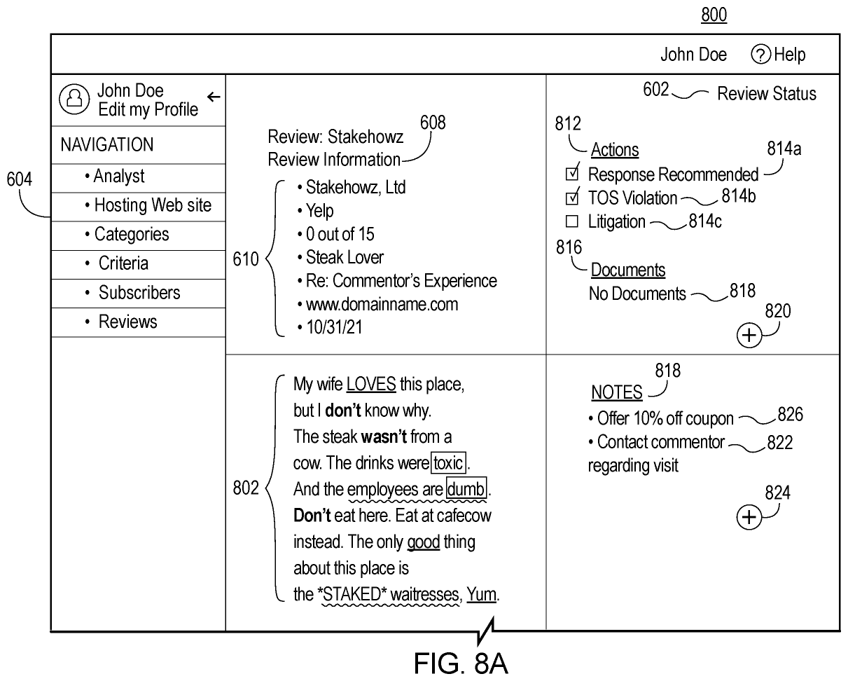

Referring to FIG. 7, in an embodiment, the analyst may be able to view a graphical user interface (GUI) for each category revealed by software analysis. The GUI (700) may include a category header (702), category information (704), search terms (706), an add button (708), and a navigation bar (604). The analyst may use GUIs such as this (700) to manage, modify, configure, edit, and other such similar tasks, each evaluation category, subcategory, and the like. The category header (702) may indicate the name for the determined evaluation category such as Terms of Service (TOS) violations, Defamation/Slander, Inaccurate/False Statements, as a few nonlimiting examples of evaluation categories that may be revealed by analysis of the standards. In an embodiment, the Web browser running on analyst computer (12) may request the Web page including the GUI (700) from the server (28a), which may then communicate with server (28b) to retrieve the requested Web page and database (26) contents via server (28c). Server (28a) may then return the requested Web page to analyst computer (12).

Using TOS violations as an example, information about this evaluation category may be listed (704) under “Category Information.” The listed information may include any type of information deemed to be helpful to understanding the category, such as an explanation of the category (if it is not obvious from the title), how it is identified in the evaluation of a post (e.g., associated color and/or marking), subcategories (e.g., hate speech, racial slurs, discrimination, foul/inappropriate language, etc.), and hosting Web sites that the category was obtained from (e.g., Facebook, Yelp, etc.) to name a few nonlimiting examples. In an embodiment, the analyst, artificial intelligence (AI), or a random selection may choose the color and/or other identifier to associate with a particular evaluation category.

The GUI (700) may also include a list of search terms (706). Initially the search terms (interchangeable with “keywords”) may include only those determined from the analytics software or as input by the analyst. However, the list of search terms may be modified by adding (708) or deleting search terms from the list as needed. For example, as posts are evaluated, new search terms may be learned and added to the list (706), hence to the database (26). Search terms may be learned by the analyst and manually added to the list (706), by software analysis such as natural language analysis, neural networks, deep learning (which may automatically add learned terms to the list), and by combinations thereof. Additions, deletions, and other modifications may, in an embodiment, take place via communication with the server system (24). As one nonlimiting example, manual modifications via GUI (700) may take place via analyst computer (12) communication with server (28a). Server (28a) may pass necessary information to server (28b). If the information/data requires processing, then the server (28b) may execute the processing and store results in database (26) via server (28c) and/or return the results to analyst computer (12). As another nonlimiting example, where processing on a server such as server (28b) has taken place without user input, results from such processing may also be stored in database (26) and displayed on GUI (700) when subsequently requested.

In certain embodiments it may be desired to have an evaluation subcategory serve as a category and vice versa. Again, using TOS violations as an example, TOS subcategories may include, without limitation, hate speech, racial slurs, discrimination, foul/inappropriate language, defamation/slander, authenticity, and the like. The analyst may select a subcategory such as defamation/slander and/or authenticity, to be a primary evaluation category. This may be as easy as using a GUI (not shown) with a hierarchical listing of categories/subcategories to click on a category or subcategory and change its place in the hierarchy. Alternatively, the analyst may click on the name of a subcategory to access a GUI similar to GUI (700) and change the status from subcategory to category. Thus, evaluation categories and subcategories may be changed via either or both forgoing mechanisms and any other mechanism as is known in the art.

A subcategory may be changed to a category and vice versa for many reasons. At least one reason may be to accommodate one or more subscriber evaluation requests. Another reason may be due to machine/human learning over time and evaluation of posts. As such, categories, subcategories, search terms and the like may be dynamically altered based on circumstances, understanding, changes in standards, and other such influences.

In an embodiment, an evaluation category may be desired, but not revealed by the examination of the standards by software analytics. One such category may be added (e.g., by the analyst) to detect compliments/affirmations during post evaluation, while another such category may be added to detect negative opinions. Since evaluating posts may be a dynamic process, other categories, subcategories, search terms, etc., may be added or deleted as other risk factors are identified (e.g., by a machine and/or a human) that may make a post unreliable, inappropriate, or both. Additional categories may be added via the GUI (not shown) having the list of categories/subcategories or any other means as is known in the art.

Notably, different evaluation categories may have different subcategories, search terms, and the like. Positive statements will differ from TOS violations, negative statements, etc., but may still overlap with one another, e.g., a TOS violation may also be a positive statement. The distinction between other categories/subcategories may not be as clear cut, and in fact may have considerable overlap in some cases. Nevertheless, distinct categories may be maintained since different subscribers may have different evaluation requests and if a search term was eliminated from one list due to overlap with another, that term may be missed if the category in which it remains is not selected for post evaluation. Furthermore, it should be noted that, standards are either (i) specific standards for the hosting Web site, (ii) other evaluation categories/subcategories leading to content that is unreliable, (iii) other evaluation categories/subcategories leading to content that is positive in nature, and (iv) combinations of the forgoing.

One or more evaluation categories, whether revealed from analytic software analysis of standards or identified another way, may be reclassified as evaluation “criteria” rather than an evaluation “category.” Generally, the distinction rests on the assumption that additional evaluation/analysis of the post may need to be taken with criteria as compared to categories. For example, authenticity may be characterized a TOS on several hosting Web sites. Generally, authenticity relates to making misrepresentations as being violative of hosting Web site standards. For example, a commentor cannot misrepresent him/herself such as by impersonating someone whether real or imaginary, making a fake account, artificially promoting or criticizing content, and other such inauthentic behavior. It is difficult to tell if a post is “authentic” by search term recognition alone. As such, authenticity, and other such criteria may be classified differently from other categories to easily distinguish information relating to standards that may need additional analysis beyond initial post evaluation.

As was previously mentioned, AI may be used to initially populate the database (26). AI, however, may be used to continually update the database (FIG. 2 at [208]). AI may be used to identify/optimize evaluation categories, subcategories, criteria, search terms and the like, which, in turn may be used to update, modify, optimize, etc. the database (26) and thus, for use in subsequent post evaluations. Furthermore, AI may also be used to learn facts. As one example, AI may be capable of identifying and validating true statements or untrue statements, or flagging certain statements as being questionably true. As AI continues to learn, classifications, characterizations, and the like may similarly evolve according to embodiments. Of course, AI is not the only way to learn new categories, subcategories, associated search terms and the like. Humans too may recognize various patterns and as such may also continue to modify/update the database (26) contents (FIG. 2 at [210]).

It should be noted that humans and machines interact with data in ways that do not necessarily agree. For example, in embodiments GUIs are used to enable humans to interact with the system (10) and methods, data, etc. supported by the system (10). Data, however, as it is organized in the database (26), may be subject to one or more database management systems that may link, match, index, and/or associate the data by another type of relationship (and combinations thereof) to enable simple and/or complex processing, storage and retrieval.

Referring back to step (202) of FIG. 2, the system (10) may again locate a hosting Web site such as Web site (18), or it may still be in communication with the hosting Web site (18) over the network (16), for example from a previous search for posts and/or standards. When searching for a post of interest the method (200) may move to step (212) where the Web site is scanned for one or more posts of interest (POI). A post on the hosting Web site may be flagged as a POI if it is new and relates to a subscriber, is new and has a high likelihood of violating the hosting Web site's (18) standards, or both. Posts are new if they were not previously present on the hosting Web site (18) in their current form. Thus, if a post has been changed it may be flagged as a new POI. Old posts without any changes are typically not flagged as a POI. A post may also be flagged as a POI if it relates to a subscriber; it may name the subscriber's business, a product or service offered by the subscriber's business, a person associated with the subscriber's business (e.g., president, CEO, owner, independent contractor, certain employees, without limitation), and other such relationships. A post may also be flagged as a POI in those instances where posts are evaluated at the hosting Web site (18), and it is found to violate one or more Web site standards. As another option, a post may be preliminarily evaluated for standard violations that are easily identified (e.g., objectional language) or an egregious standard violation (e.g., death threats) and then be flagged as a POI. If a hosting Web site (18) is scanned and none of the posts are flagged as a POI, no further action is required. Thus, the system (10) may move on to another hosting Web site to scan for POIs. A hosting Web site (18) may be scanned for POIs according to a predetermined interval such as every day, twice a day, once a week, or the like. The predetermined interval may be different for different hosting Web sites (18) due to Web site traffic or another condition that would cause a hosting Web site (18) to be scanned more or less frequently.

Once found, a POI may be copied, scraped, or otherwise extracted (214) and stored in the database (26) via server system (24). In an embodiment, the POI may be copied before being evaluated. In an embodiment, however, the POI may be copied after a preliminary or full evaluation. Although typically desired, a method does not require a POI to be copied to the database (26). Alternatively, only a portion of the POI may be copied to the database (26). Further, metadata for a copied POI may also be captured (212) and saved to the database (26). In an embodiment, steps (212) and (214) may be performed by a processor-based system such as server (28b), although embodiments are not so limited. These steps may be performed by a different processor-based system or server and/or by the analyst.

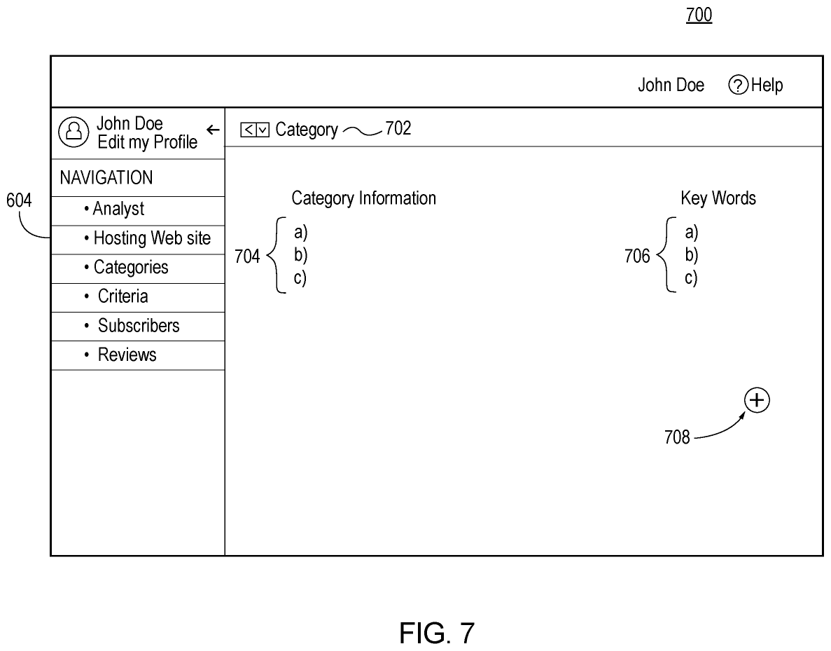

Referring to FIG. 6, an exemplary GUI (600) is shown that enables an analyst to add a post (interchangeably with “review”) to database (26), among other tasks. Interactions between analyst computer (12) and server system (24) with respect to GUI (600) is substantially the same as or similar to that described with respect to GUI (700). The GUI (600) may include a status indicator (602) navigation bar (604), an “Add Review” button (606), Review Information (608), Review Information Elements (610), a “Save” button (612), and a “Save & Add” button (614), although embodiments are not limited to particular GUI designs, features, or both.

The status indicator (602), on the right side of the GUI (600), may show a current status of the post. A current status may be any descriptive status that easily identifies where a post is in its examination. A status may be described as new, waiting for evaluation, evaluated—no recommendations, evaluated—with recommendations, recommendations sent, instructions received, removal requested, issues resolved, or any other descriptive words or phrases.

The left side of the GUI (600) shows a navigation bar (604). The navigation bar (604) includes a nonlimiting set of navigable features, including analysts, hosting Web sites, evaluation categories, evaluation criteria, subscribers, and reviews (e.g., posts). Although not shown, other navigable features may include administration, service partners, and the like.

Still referring to GUI (600), the analyst may click on the “Add Review” button (606) to receive a blank GUI (600) if it is not already blank. Review Information (608) lists several pieces of information/elements (610) related to the POI including the subscriber's name, hosting Web site/platform (i.e., the name the Web site/app, IP address, and the like), the number of stars given with the POI (if applicable), the commentor's name, a subject of the POI, a URL for the POI, Web site, or other associated Web address (if applicable), the date the POI was posted, the number of ratings of the POI (if applicable; not shown), and the content of the post, as nonlimiting information/elements.

The content of the POI may be typed text regarding a particular business, or it may be in another form that are readily available to commentors. For example, the content can be selected from the group consisting of text, video, a GIF, an image, and combinations thereof. Forms of content may be dependent upon the hosting Web site (18) as certain Web sites are better able to host different forms of content or combinations of content. As one nonlimiting example, a hosting Web site (18) may be geared toward video content with text as supplemental content.

In an embodiment, Review Information/information elements (608, 610) may be manually entered by the analyst such as by typing the text or by copying and pasting information from the hosting Web site (18), or both. In an embodiment, Review Information/information elements (608, 610) may be captured automatically once the system (10) and machine learning are trained to capture the same. In some embodiments both manual and machine learning may be used to capture the desired Review Information/information elements (608, 610).

Capturing Review Information/information elements (608, 610) provides a snapshot of the information associated with the POI and the POI itself. Once all information is entered, the analyst may click either the “Save” button (612) or the “Save & Add” button (614). Clicking the “Save & Add” button (614) saves all entered information and reloads a blank GUI (600) to enter an additional POI. The data entered via GUI (600) is saved within the database (26). Preferably, the system (10) saves information regarding the POI to ensure capture of the initial post in its native form, as well as capture of all relevant information regarding the commentor. For example, data should also include the IP address, a post time, and any other relevant metadata that can be collected to identify the time and location of the post, which may be relevant to confirm the identity of the commentor should it be warranted for authentication. If the analyst elects to abandon entry of a POI, the analyst may click the “Cancel” button at any time. Furthermore, the analyst may retrieve a saved GUI (600) to amend or modify information.

Referring to FIG. 2, at step (214), if a POI and associated information has been saved it will enter a queue for evaluation (216). Alternatively, a POI may undergo evaluation (216) before being saved, if saved at all. Generally, a POI may be examined to determine if it is appropriate or inappropriate. Appropriateness has nothing to do with whether the post is positive or negative, good or bad, or the like. Rather, it has to do with whether the POI abides by certain standards such as the specific standards of a given Web site, general standards evoked by many Web sites, legal standards adopted by various levels of the government (e.g., local, state, federal), and combinations thereof. Thus, evaluation of a POI seeks to ensure that it is accurate, truthful, and/or authentic (e.g., not fake) regardless of the position taken by the commentor and that does not violate various standards. In other words, appropriateness does not distinguish between a positive connotation and a negative connotation, for example, or a neutral comment, or a post that allows a rating from 1-10 stars, 1-5 stars, etc. that is not glowingly positive for a business, but simply seeks to identify posts that violate standards (i.e., by annotating the POI, which is discussed below) and flagging a POI having violative content (or potentially violative content) as problematic. In an embodiment, evaluating a POI may include grading, receiving a score, being further evaluated, receiving other commentary regarding violative content, and combinations thereof. In the simplest terms, a goal of evaluation is to determine if a POI and/or the content within the POI is valid, or if it violates one or more standards and thus needs to be removed or modified.

Referring to FIG. 2, once found, a POI may be evaluated (216) for appropriateness, as is explained in the paragraph above. In an embodiment, the evaluation of a POI may begin by selecting evaluation categories (218), or all categories are automatically selected for review. The selected evaluation categories may be via a default setting (e.g., all, most common, most egregious), a level of subscription plan (e.g., basic, advanced, optimum), or subscriber choice, to name a few nonlimiting examples. Nonlimiting examples of selectable evaluation categories includes compliments/affirmations, defamation or slander, negative opinions, statements of truth, and standard/TOS violations.

In an embodiment, the analyst may determine if a particular category should be considered a positive attribute such as compliments/affirmations or a negative attribute such as defamation or slander. Evaluation categories, however, do not necessarily need to be identified as positive or negative, but such identification may be helpful to a grading/scoring scheme, as is discussed below. Furthermore, if an evaluation category is identified as positive and it is found in a POI, a subscriber or other target of the post may consider replying to the POI or possibly offer an incentive or reward (e.g., a coupon, free samples, etc.) to the commentor. In some cases, an evaluation category may be ambiguous as to whether it is positive or negative in nature. For example, statements of truth may be geared toward finding truthful statements, and as such could be identified as positive. Alternatively, statements of truth may be geared toward finding false statements/misrepresentations or the like, and as such could be identified as negative. In an embodiment, statements of truth may be geared toward both truthful and false statements, the nature of which (positive or negative) may be made in a subsequent determination, if at all. In a preferred embodiment, this evaluation category creates a list of terms related to veracity (e.g., during creation and maintenance of the database (26), see FIG. 2 at steps (206)-(210), and this list of terms is utilized to check for the truthfulness of statements within a POI.

Selecting evaluation categories (218) invokes search terms associated with those categories to be retrieved (220) from the database (26). These search terms may be utilized to find matches (222) in the POI content, associated data (e.g., information/metadata), or both relating to standards violations and/or positive statements. In an embodiment, server (28b) or another such server may use search terms from database (26) to search the POI for matching terms. Logic used for finding a match may be implemented in one or more ways. As a few nonlimiting examples, the POI may be sequentially searched by selected evaluation category for matching search terms, an algorithm may be used to compare the POI to search terms associated with multiple selected evaluation categories, and/or AI may be used to learn certain parameters to enable identification of evaluation category matches. In this manner, a comparison in made between the POI and the terms listed in the standards. Where a match is found, then the POI is annotated in one or more ways. Regardless of how comparisons are made, the results of the evaluation (e.g., matching terms) are shown on a marked or annotated version of at least the content of the POI (224).

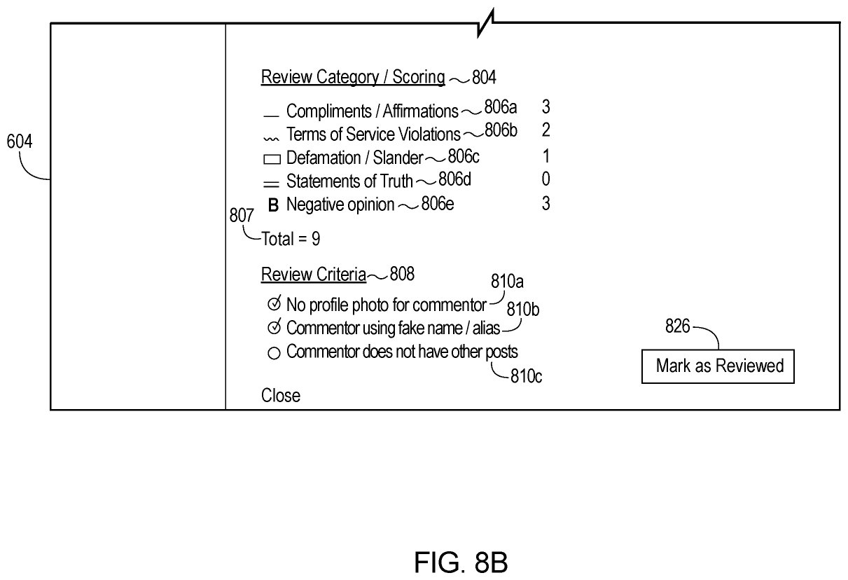

As is indicated in FIG. 2 at (224), the results of the POI's evaluation may be visually marked to easily identify evaluation categories with respective matches. With text and similar content, a color of choice may be associated with a particular evaluation category and text corresponding to a search term match for that evaluation category may be highlighted in the color of choice. Alternatively, or additionally, evaluation categories may each be associated with another visual indicator of choice, such as a font feature (bold, italics, underline, small caps, etc.), and search term matches are identified by the other visual indicator or by both color and the other visual indicator. As one example, text in the POI may be underlined or highlighted in a color corresponding to a given evaluation category, and the name of the given evaluation category may be displayed in the same color in a marking/annotation legend (e.g., FIG. 8B at [804]). In this way, it may be easy to understand which evaluation category is associated with the highlighted words/phrases in the POI content. In the instance of video content, video equivalents to visual overlays, font features, or both may be used, although embodiments are not limited thereto and may use any form of known video marking capabilities as is known in the art.

Referring to FIG. 8A, the analyst may see evaluation results by viewing the results in GUI (800). The analyst may use the navigation bar (604) on a current page to retrieve the results for a particular POI. In an embodiment, the analyst may navigate to an overview page (not shown) that lists POIs by hosting Web site, subscriber, status, analyst, commentor name, or the like. The overview page may also list one or more of the subject of the POI, the POI content, an authentication rating, the date the POI was posted, the date the record for the POI was created/updated, and a score to name a few nonlimiting examples. When a file for a particular POI is retrieved (e.g., from server system [24]), all previously entered information may be displayed in GUI (800). In the present example (FIGS. 8A and 8B), the window shows results of an evaluation that has already taken place. The evaluation may have occurred sometime before and the results are being returned to, or the evaluation may have just taken place and the results are being displayed for a first time.

In the nonlimiting example shown in FIGS. 8A and 8B, the review information (608) may be shown at the top of the page, next to the navigation bar. In this example, the POI relates to “Stakehowz” restaurant. Review information (608) may have been previously entered via GUI (600). The same review information (608) may be displayed with the evaluation results (e.g., GUI [800]). In this hypothetical example, review information elements (610) include, but are not limited to: “Stakehowz, Ltd.” (subscriber name), “Yelp” (the hosting Web site on which the POI was found), 0 out of 15 (the number of stars given by the commentor), “Steak Lover” (the commentor's name), “commentor's experience” (subject of the review, which may be provided by the commentor, the analyst, or determined via AI software), the URL for the POI/hosting Web site (if available), and “10/31/21” (the date the POI first appeared on the hosting Web site). It should be noted that the review information/elements (608, 610) shown in FIG. 8A, are just a few nonlimiting examples of review information/elements that may be associated with a POI; other/additional types of information may be associated with the POI and shown as review information/element (608, 610). In any particular instance, review information/elements (608, 610) associated with a POI, subscriber, or the like, may depend upon information that is available, relevant to the situation, and/or other information conditions.

In exemplary GUI (800), a marked/annotated version of the POI's content (802) is shown just below the review information/elements (608, 610). Generally, the marked copy of the content is an exact replica of the POI content that includes coded annotations/markings corresponding to the selected evaluation categories (FIG. 8B, [806a]-[806e]). In this way, it is easy to identify content that triggered a match with search terms for a particular evaluation category. In a preferred embodiment the markings are color coded highlights over the triggering content whereby each evaluation category is identified by a distinct color. In an embodiment that identifies subcategory matches, the distinct subcategories may be marked by shades of a category color (e.g., category is blue, and each subcategory being coded to a shade of blue). Further embodiments may utilize indicia such as underlining (straight, double, wavy), font style changes (bold, italics, size, shading, shadow), font type changes (Times New Roman to a script-type font), putting matching terms in a box, and combinations thereof to code to evaluation categories. Since distinct markings/annotations in the POI content correspond to different evaluation categories, content violations may be matched to the particular issue. For example, certain issues can be highlighted in one color, and another violation in another color. This allows certain violations to be collected, even when they are not directly adjacent in POI content, or if there are multiple violations within a single POI.

Referring FIG. 8B at (804), a review category/scoring section is shown. In this hypothetical, five evaluation categories (interchangeable with “review categories”) were selected to evaluate the POI's content (802): compliments/affirmations (806a), terms of service violations (806b), defamation/slander (806c), statements of truth (806d), and negative opinion (806e), each of which may relate to Web site and/or other standards. In an embodiment using color coding, each selected evaluation category may be displayed under the heading (804) in a previously selected color, which will be used to highlight content corresponding to search term matches. For example, the title “compliments/affirmations” may be displayed in red, and any matching content (802) would be highlighted in red. Thus, whoever is looking at the results pane can easily identify content that matches search terms for “compliments/affirmations.” In this example, however, each evaluation category (806a, 806b, 806c, 806d, and 806e) is preceded by a distinct marking (e.g., underline, wavey underline, box, double underline, and bold, respectively), which is used to identify corresponding search term matches within the content. Therefore, color coding and/or other indica/metric may be used to annotate/mark content in a POI believed to violate the standard that corresponds to the coded color, indicia, or other metric. In the same way, other content corresponding to other evaluation categories such as positive input may also be easily identified. This provides a visual approach to differentiating between one potential violation and another, so that a reviewer can easily identify both the possible language in the POI and also compare it to the precise language in the standard to determine whether such violation is accurate.

Referring to the text shown at (802), content that matched search terms associated with compliments/affirmations (806a) are underlined. Here the terms “love,” “good,” and “yum” are each underlined to indicate that these terms match search terms for the compliments/affirmations evaluation category (806a). Similarly, text that matched search terms associated with evaluation category of TOS violations (806b) are underlined with a wavy line such as, for example, “employees are dumb” and “*STAKED* waitresses” as they may relate to hate speech, discrimination, exploitation, bullying, harassment, or the like. In an embodiment, evaluation category defamation/slander (806c) may be a subcategory of TOS violations (806b), but in the example shown in FIG. 8 it is a separate evaluation category, which is coded by having a box placed around potential violations. In this example, the text “toxic” and “dumb” are boxed as possible violations. It may be noted that, the term “dumb” is also underlined with a wavy line as it was separately matched a different TOS violation. In embodiments, however, once a match is found and coded to an evaluation category, additional matches may not be visually marked. This is especially true in embodiments using color coding to visualize evaluation category hits/matches since it may be confusing as to which color should be displayed. In other embodiments, a color coding can be overlapped on one another to display multiple violations on the same text. With respect to the evaluation category statements of truth (806d), no matches were found in this example according to the evaluation category parameters. In this instance, statements of truth (806d), may have been geared to identify truthful statements, and as such did not find any search term matches. In another instance, however, statements of truth (806d) may be geared to identify false statements, and in that case the terms “toxic” and “wasn't from a cow” may be marked according to the marking system employed (e.g., a double underline [806d]). Another evaluation category used in this hypothetical is negative opinion (806e) in which search term matches are marked in bold. Here, each instance of the words “don't” and “wasn't” was bolded to designate matches with search terms associated with a negative opinion (806e) evaluation category. Thus, coding by annotation/marking may identify several issues with POI content at the same time. As another example, POI content that contains factual errors, can also be annotated/marked regarding hate speech or derogatory language, each of which are separate violations of the standards.

It should be noted that in a preferred embodiment, the processing that yields the marked/annotated version of the POI content (802) was performed by a server such as server (28b). Thus, when the Web browser on a computer (e.g., [12], [20], [22]) requests the Web page that will display GUI (800), the page together with the appropriate data from the database (26), will be returned to the requesting computer via server system 24, in the same or similar way as was described with respect to FIGS. 6 and 7.

A “Review Status” indicator (602) is at the top right of GUI (800) and various other GUIs such as GUI (600). Generally, the “Review Status” indicator (602) gives the viewer (e.g., analyst, subscriber, service partner) an at-a-glance determination of where a particular POI is at in the examination process. For example, in the hypothetical of FIG. 8, the evaluation has been completed. Thus, the review status indicator may be changed to indicate “analysis complete” or the like. Furthermore, it may also indicate if a recommendation is, or is not, provided (e.g., “Analysis complete—no action recommended (done),” “Analysis complete—action recommended (waiting for subscriber)”), or the like. Thus, Review Status indicators may be changed during examination to correspond to a current stage of POI processing.

Below the Review Status indicator (602) is a “Documents” pane (816). In an embodiment the analyst, subscriber, or service provider, and combinations thereof, may upload documents to be saved in association with the POI's file. For example, the analyst may attach a screen shot of the POI on the hosting Web site (18) at the time it was found. This screenshot may help confirm that the POI was not altered when copied or scraped. In this example, no documents (818) have been uploaded and saved as an associated file. In an embodiment, certain documents may be required to be attached to the POI file. In this case, the required documents (818) may be listed under the heading (816). And in an embodiment, an icon may indicate if a required document has yet to be uploaded. Additional examples of documents that may be uploaded and save via the documents section include, without limitation, copies of letters, e-mails, and other correspondence, legal documents, and the like.

An embodiment of GUI (800) includes a “Notes” pane (818). Notes may relate to recommended actions based on the evaluation of the POI. In the example shown in FIG. 8, a note suggests offering a coupon (826) to “Steak Lover” or to contact “Steak Lover” regarding his visit (822). These are nonlimiting examples of notes that could be added by an analyst; the analyst (or another) may use the notes space to enter detailed comments in his/her own words. Indeed, a purpose of the notes (818) is to enable the analyst or another person to look at the file, including the evaluation and provide input on how to proceed. The subscriber (e.g., Stakehowz) in turn, may view at least a portion of the POI file, including the notes to comment on, notes already made, and/or additional notes. Again, the notes may help a subscriber ensure it is satisfied with the outcome for a particular POI evaluation. In an embodiment, notes may be accompanied by a date and time stamp, and the identity of the person who entered and/or altered a note.

As has been alluded to, the analyst may take an active role in POI evaluation. In an embodiment, the analyst may supplement an automated evaluation process. As one example, an analyst may want to check the automated results for “false drops” (e.g., technical matches that are irrelevant to the situation), identify and annotate/mark words/phrases that should be included as additional search terms, but were not and the like. These manual modifications may be especially important during various stages of AI training. Referring to FIG. 7, the analyst may add new search terms using button (708) and copying it to the database (FIG. 2 at [210]). Similarly, if a current search term consistently identifies false drops, it may be removed from the search term database either manually or via AI software, for example, running on server (28b).

In certain embodiments, POI evaluation may be performed completely by the analyst. This is especially true in the situation where embodiments of the system and methods are in their infancy of development. For example, the analyst may identify different words within the POI content as corresponding to compliments or affirmations, TOS violations, or statements of truth. The analyst may use GUI (700) to designate the color for each category and add identified words to the search term list. These categories will then be aggregated (e.g., in GUI [800]) and displayed in the review category/scoring panel (804) where the analyst can toggle between categories/GUIs as needed.

As is shown in FIG. 2 at (226), an authentication process (e.g., a type of evaluation criteria) may be optionally utilized in an embodiment of the present invention. Authentication may take place after evaluation, but it may also take place before evaluation or concurrent with evaluation. Whether or not a given POI is authenticated may depend upon the circumstances related to the POI, a level of subscriber agreement, by subscriber request, and combinations thereof. For instance, authentication may be desired where there is evidence of a POI being fake. The evidence may be observed by an analyst or other person, AI parameters, and combinations thereof. Inauthentic/fake POI's may be prohibited by the hosting Web site (18) as part of its standards, undesired due to their lack of credibility, or both. Credibility is important to a subscriber, but it is also important to persons who rely on posted content to make determinations about a business. Thus, it may be in the subscriber's best interest and in the public's best interest to ensure that inauthentic posts are modified or removed from a hosting Web site.

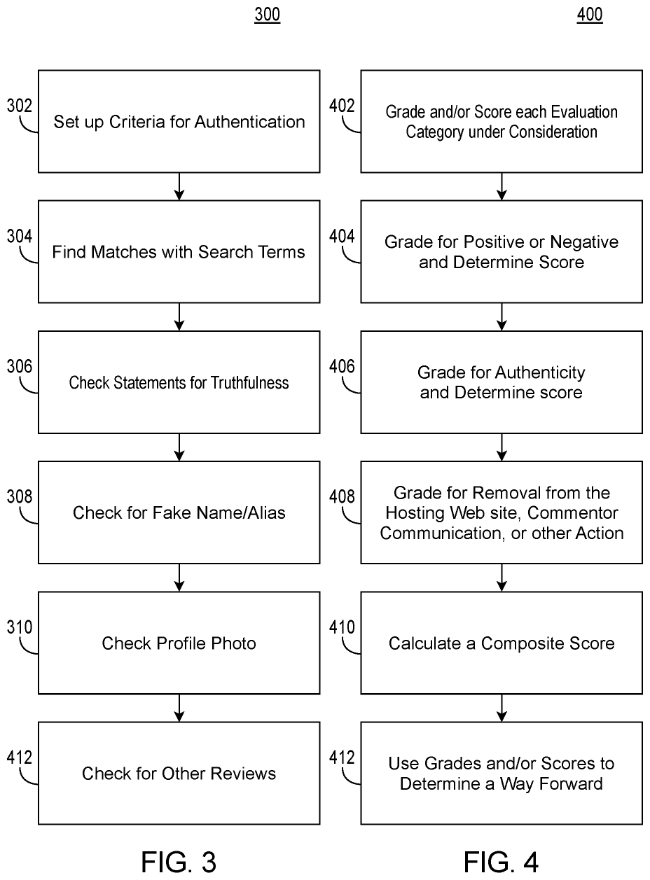

Referring to FIG. 7, a GUI similar to GUI (700) may be used to set up evaluation criteria (FIG. 3 at [302]). In an embodiment there may be criterion information, search terms, or both associated with an evaluation criterion such as authenticity. In this way, search term matches may be found during initial POI evaluation just like an evaluation category. Evaluation criteria, however, typically, but not always, require additional analysis. Thus, the GUI for an evaluation criterion may also include specific conditions to be examined beyond search term matching. For example, with respect to authenticity, conditions pointing toward violations/indicia of inauthenticity may include, without limitation, one or more of: (i) the commentor's use of a fake name or alias, (ii) the commentor has minimal information in the commentor's profile and/or lacks a photo, (iii) the commentor does not have any other posts associated therewith, (iv) the POI includes positive statements directed toward a competitor of the subscriber, and (v) the POI includes false statements that may be overly positive or inaccurate, misleading, or wrong. Evaluation criteria and associated conditions may be extracted from standards as was previously explained with respect to categories. Furthermore, evaluation criteria and/or associated conditions may be manually input and/or modified such as via an add button or the like.

Thus, at some point during analysis of a POI, the analyst may examine evaluation (interchangeable with “review”) criteria. For instance, if the analyst observers a “red flag” while initially transferring POI information to the database (26), the analyst may look at authentication conditions at that time. Alternatively, the analyst may be inclined to investigate authentication in response to a search term match (FIG. 3 at [304]) during evaluation, or as a regular part of routine POI evaluation.

Referring to FIG. 3 at (306) the analyst may note that the POI includes statements that seem untrue, farfetched, exaggerative, or the like. The analyst may then investigate the suspect statements. In this example of Stakehowz (FIG. 8A at [802]), the commentor stated “the steak wasn't from a cow,” “the drinks were toxic,” and “Eat at cafecow instead.” Each of the statements may cause the analyst to investigate the truthfulness of the statement. With respect to the source of the meat, the analyst may research into whether at least some of the steaks are plant-based, and if not, verify that all meat served is beef. If some steaks are indeed plant-based, then the statement may be true, but nevertheless misleading. Similarly, the analyst may also investigate whether drinks are indeed toxic or have the term “toxic” in the drink name or the like. Again, the statement may prove to be misleading if not outright false. The reference to a competitor may be an immediate red flag to an analyst, which may cause the analyst to investigate if the POI was made by, or on behalf of, Stakehowz's known competitor “Cafecow.” If it is discovered that Cafecow or someone on Cafecow's behalf (known or unknown to Cafecow) was behind the POI, there is an increased risk that POI violates a hosting Web site (18) standard (such as lack of integrity, inauthentic behavior, etc.) or another standard (e.g., unfair competition) specifically by being inauthentic.

If the commentor who posted a POI is using a fake name or alias (e.g., “Steak Lover”) the analyst may try to determine if the commentor is real or fictitious. Commentors using a fake name or alias, may merely want to remain anonymous, but these commentors may be hiding behind a fake name or alias to post inauthentic comments (e.g., false, misleading, or the like). Again, a fictitious person displays a lack of reliability, as compared to an opinion from a real person. Although shown after step (306) in FIG. 3, it should be noted that this step may occur at various points in POI processing, and embodiments are not limited to a particular sequence of steps. Regardless of whether the commentor is posting an authentic comment, where fake images or names are a TOS violation, the post may still be flagged and marked for removal based on such TOS violation.

If the commentor's profile lacks a photo (FIG. 3 at [308]) this may also suggest that the profile was hastily setup and is not associated with a real person. Furthermore, if the commentor has not posted any other content (FIG. 3 at [310]), this may also suggest that the commentor created a profile created for a single purpose (e.g., to target a particular business such as a subscriber's business), and it is not real. Some of the conditions relating to evaluation criteria directly contradict the standards of many hosting Web sites (18), while other rules may be common sense regarding real or fictitious commentors/profiles. Such criteria are set forth within the standards in the database and can then be manually or automatically annotated in the POI and scored.

The results of verifying that a post is real, that a profile is real, and that the information posted is truthful may each be displayed in GUI (800). The Review Criteria pane (FIG. 8B at [808]) shows a list of selectable evaluation criteria conditions. The analyst may check a circle or box (or the like) next to the condition to indicate whether or not the condition was or was not met. For instance, the conditions at (810a) and (810b) are checked indicating that the commentor did not have a photo associated with the commentor's profile and that it was determined that the commentor was using a fake name or alias to submit the POI, respectively. At condition (810c), however, the circle is not checked, indicating that the commentor made other posts using the same account. Thus, the review criteria pane (808) allows the analyst to specify the reason for which the review was flagged for analysis, for example, the commentor does not have a profile picture, used a false name or an alias, or mentioned a competitor in a positive light as a few nonlimiting examples. In the “Actions” pane (FIG. 8A at [812]), the analyst may recommend courses of action while taking the results of investigating evaluation criteria conditions into consideration.

Although investigation of evaluation criteria has been explained as a manual process, evaluation criteria/conditions may also be processed automatically (e.g., on server [28b] or similar server) through intake of data or information via machine learning technologies. In an embodiment, both machine learning and manual processing may be employed.

Thus, embodiments of the system/process described herein check for truthfulness in combination with other checks, to identify both standards violations and authenticity questions relating to a POI. Embodiments above, therefore, may relate to systems/processes for determining whether a post is authentic and whether it violates rules and regulations. Notably, these steps may be performed in a variety of sequences, and in an embodiment simultaneously.

Referring to FIG. 2 at (228), embodiments of the system/methods described herein may include one or more schemes for grading and/or scoring the POI. Certain aspects of grading/scoring may depend upon evaluation results, authentication results, or both, and thus, those aspects of grading/scoring may take place after these results are obtained. Certain aspects of grading/scoring, however, may take place at essentially the same time as evaluation results, and perhaps authentication results.

Now referring to FIG. 8B at the “Review Category/Scoring” pane (804), a number may appear to the right of each evaluation category. These numbers are indicative of a score received for each evaluation category, as is indicated in method (400). Thus, each evaluation category may be graded (e.g., evaluated) and given a score (402). In an embodiment, each category may receive a binary score of zero or one. An evaluation category would receive a score of zero in the absence of any matches between search terms for the particular evaluation category and the content of the POI. Alternatively, the evaluation category would receive a score of 1 if even one match is detected. Since this is an example of a binary scoring system additional matches do not increase the score. Thus, in an embodiment a total score (FIG. 8B at [807]) for all evaluation categories may range from zero to the total number of evaluation categories being examined. This is one nonlimiting example of grading/scoring that takes place at essentially the same time as evaluation results are compiled.

In another embodiment, each evaluation category may receive a numerical score based on a count of the number of matches detected during evaluation. For example, referring to FIG. 8A at (802) and FIG. 8B at (806a)-(806e), the compliments/affirmations category has a count of three due to the three marked matches, the terms of service category has a count of two due to the two marked matches, the defamation/slander category has a count of one, and the negative opinion category has a count of three due to the three marked matches. As no matches for statements of truth were found in this hypothetical, the count for this category is zero. Thus, the total score (807) for the content of the POI (802) is 9. Referring to the defamation/slander category, it makes sense that it should have received a count of two since two boxes are found in the markings/annotations (802). In an embodiment, however, if a search term has already been counted as a match for one evaluation category, it will not be counted as a match for another evaluation category, although embodiments are not so limited. Furthermore, the evaluation category to which a double match is assigned for scoring purposes may simply be a function of the category search term that was the first to recognize to match, although embodiments are also not limited in this respect. In an embodiment that counts the number of search term matches per category, the count may reach a maximum such as 10. Thereafter additional matches are no longer counted.

In a preferred embodiment, a scoring system comprises assigning a score from 0-10. Each incremental point is generated by the occurrence of an additional feature being calculated. Thus, where the score is determining content that is defamatory, for example, a series of search terms may be populated within the database (26) and the POI is annotated/marked against those words with each annotation/marking being counted. Thus, the absence of any search terms from the database being present, yields a score of 0, the presence of one term yields a score of 1, two terms 2, three terms 3 . . . ten terms 10, and more than ten terms also 10. This is a simple scoring metric to generate a relative score for each evaluation category examined in the POI, which may be summed to provide a total score for all evaluation categories, although embodiments are not so limited. The total score may be indicative of the relative number of issues that may be present within the POI. The total score may, in an embodiment, be used to rank a POI by issue number and/or severity (e.g., none, small/low, medium, high/severe), and to identify a course of action to the subscriber for remediation.

In certain embodiments, some violations may be worth more points, i.e., they are more serious violations of the Web site standards, other standards, or both. Thus, a POI identified as having a negative opinion of the subscriber's business (or other target) and a positive recommendation of a competing business, has an increased indicia of unreliability as someone related to or supporting the competing business may be making the comments in the POI, and it undermines the reliability of the POI, may have one score value. In contrast, a POI that blatantly defames someone, uses curse words, makes physical threats, or other more serious violations of the standards may have a higher score. The specific value of these violations can be adjusted and modified, and multiple violations may weigh the violations to create a total score.

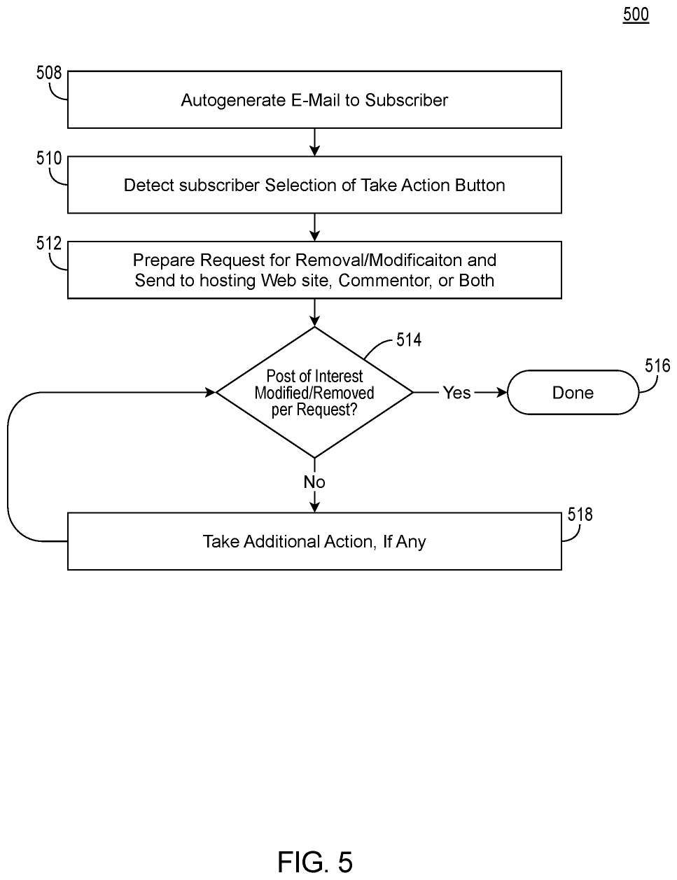

In addition to grading and scoring evaluation categories, a POI may also be graded as being as positive or negative (FIG. 4 at [404]). Overtly positive and overtly negative POIs may be suspicious as being untrustworthy/unreliable. Thus, scoring a POI from 1-10 on a negative/positive continuum (1 being negative and 10 being positive), may indicate that POIs with a score of 1 are full of factually untrue statements or blatant mischaracterization by the commentor and harm a subscriber's (or other) business based on frustration of the commentor. Similarly, glowing POIs receiving a 10 may also include untrue statements or be from commentors who have not used the business but are posting simply to “help a business” or a friend. Neither type of post is helpful to obtaining truthful and valuable information regarding a business. Therefore, posts from actual consumers and patrons of a business are desired, whether such reviews are positive or negative.

Evaluation criteria, such as authenticity, may be graded (FIG. 4 at [406]) in the same or similar way as evaluation categories, and positive or negative grading such as the aforementioned scale of 0-10. In this case, a score of 0 indicates that the POI/its content is genuine and a score of 10 indicates the POI/its content is fake, inaccurate, misleading or the like. Recall that inauthentic POIs may include conditions such as a missing picture, a single post by the commentor, using a fake name or an alias, content that includes glowing (positive) reviews of a competitor and negative reviews for others, etc., as well as certain violations of standards. Thus, in an embodiment, an algorithm may be used to determine a probability (based on the available information) that the POI is authentic (or inauthentic). The probability may be calculated as a percentage, a proportion, a fraction, a binary number, or any other way probabilities are expresses as is known in the art. Authenticity conditions, scoring, and the like may be determined by machine learning (e.g., on a processor-based system such as server [28b]) or determined by individual effort (and used to train the machine learning system). This is one example of grading/scoring that is dependent upon having evaluation results complied before grading to assign a score.

Accordingly, each standard may have its own separate score, or may be combined into a total score. Thus, a POI may have a score of 2, 3, 4, and 2, as it relates to four different categories, or may simply have a total score of 11, which would sum the total number of violations, or even a higher score, if certain violations are valued differently than another.

As is shown in FIG. 4 at (408), a POI may be graded for removal or for commentor communication. A goal of this grading category is to determine the best mechanism to address a POI. Again, a score of 0-10 may be used with 1 favoring communication with the commentor and 10 favoring a request directed to the hosting Web site for POI removal, which may help to determine a course of action. A POI that has significant violations or other issues, may be better handled by the hosting Web site and would have a higher score. A POI that has few violations, and ones that may be questionable, may be better handled by commentor communication to determine if the POI may be modified to fix any compliance issues.

The analyst may provide a grade recommendation other than for just removal or commentor communication (FIG. 4 at [408]). The goal of this grading may also be to determine the best mechanism to address a particular POI. In this case the grade may be textual, but it may also be accompanied by a number. In the case where a POI is positive and authentic (or the like) the grade for the POI may be “use compliment template and suggestion sent to subscriber to respond to commentor.” If desired, this grade may be accompanied by a number such as zero or one. In the case where standards have been violated by content in the POI, the grade may be to use a “violation of hosting Web site guideline.” This may also be accompanied by a number, which may depend on the number, type, or severity of the violations where a lower number would indicate few violations or not as severe violations and a higher number (e.g., 10) would be indicative of a higher number of violations or more severe violations. Alternatively, depending on the severity of the violations, the nature of the offensive content, or other parameters, a POI may be graded as “mark for attorney review.” If a POI is graded for attorney review, it may be associated with a 10 to warrant additional evaluation. Where a POI does not necessarily violate any standards and is authentic, yet is negative in nature, the grade may be “legitimate commentor post, suggest to subscriber to respond to commentor.” Since this type of review does not break any rules, it may be associated with a low number even though it is negative. And in the case where a POI is likely to be fake (i.e., not authentic), the grade may be “possible fake review, algorithmic probability of being fake is 70%.” Here a probability or percentage may be replaced by a number value on a scale of 1-10.

A sum of these grading/scoring elements may be reported as a total score (410) regarding the POI. Thus, one or more grading/scoring options, such as those shown in FIG. 4, may be used to determine a course of action and strategy based on the outcome of removal or modification of the post (412). Adding in a result step (not shown) may then help the machine learning (e.g., AI) determine how to best handle certain posts based on prior successes or failures with post removal or modification.

As is shown in FIG. 8A, under the “Actions” heading (812), selectable actions in response to POI evaluation are listed. Here, the listed options are Response Recommended (814a), TOS violation (814b), and Litigation (814c). The analyst should select all actions as are appropriate to the situation. In the example of FIG. 8, a note was made to offer a 10% coupon (826) and to contact the commentor (822). Thus, the Response Recommended (814a) action should be selected. Evaluation results, however, indicate that one or more standards were violated. Thus, the TOS violation (814b) action should also be selected. The litigation action option (814c) may not be selected at this time. It may, however, be selected if a resolution that is acceptable to the subscriber has not been reached after reasonable efforts have been made such as by contacting the commentor and/or hosting Web site. The selection of one or more Actions (812) may flag the POI for follow up such as being recommended for removal or modification to ensure that posts on a given hosting Web site (18) are meeting the minimal standards as set forth in that hosting Web sites (18) standards. Other nonlimiting recommendations may include letting the POI be (i.e., do not take any action), to reach out to the commentor, to seek removal of the POI by either contacting the hosting Web site (18), the commentor, or both, especially if the POI is in clear violation of one or more standards.

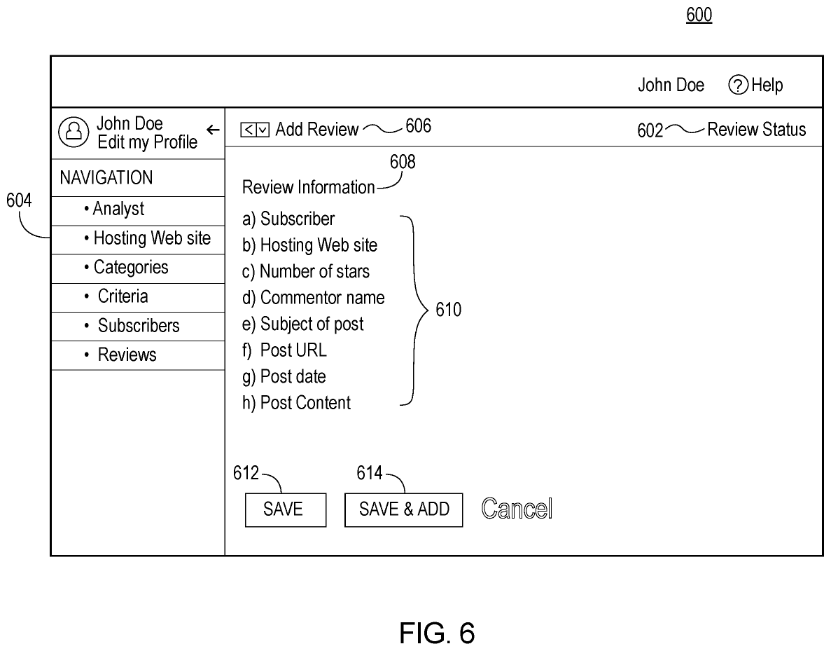

When the analyst is finished with POI analysis, adding notes, adding documents, and the like, and the analyst is ready to send an e-mail to the subscriber, the analyst may select a “Mark as Reviewed” button (826) on GUI (800). Selecting the “Mark as Reviewed” button (826) will, in an embodiment, cause an e-mail to be generated and sent to the subscriber, which is shown in FIG. 5, method (500) at step (508). Selecting the “Mark as Reviewed” button (826) may also update the status indicator (602) to “analysis complete” or another similar indication.

The e-mail sent to the subscriber may, in an embodiment, summarize the results of the POI's analysis by indicating which evaluation categories were selected and optionally whether they are considered to be positive attributes or negative attributes, identifying the evaluation category matches found in the POI, and outlining the coding scheme used for evaluation (if helpful for the subscriber to understand the analysis). The summary may also include the grading results for whether the POI was positive or negative and the grading results for authenticity.

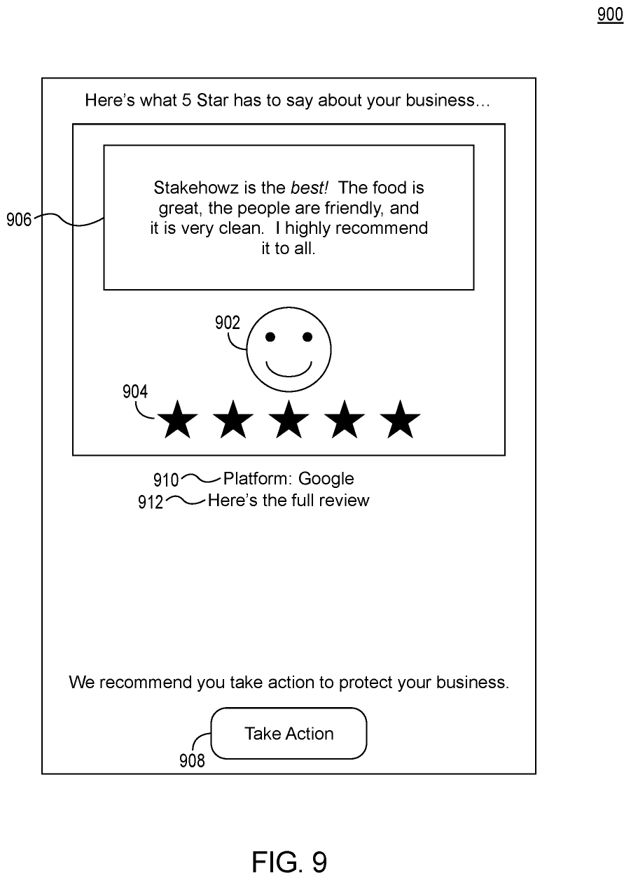

Referring to FIG. 9, the e-mail (900) to the subscriber may, in some embodiments, include a color-coded icon (e.g., color-coded faces) and star rating system to visually represent the overall grading determination for the POI. As is shown in FIG. 9, if five stars were given by the commentor, a green (not shown) happy face (902) and five star icons (904) may be shown in association with a copy of the post (906). The happy face and stars together may indicate that the POI was positive, authentic, and free from standards violations. At the other end of the spectrum, the face may be a red face with a frown together with zero or one stars to indicate that a genuine issue has been found and that the POI was negative overall. Other color-coded face icons with corresponding expressions and numbers of stars may be indicate various outcomes therebetween.

The e-mail (900) to the subscriber may also include at least one selectable button (908) that, when selected (by the subscriber) causes the system/process to instigate the recommended action (see FIG. 5 at [510]). For example, in an embodiment, a recommended action may be provided (e.g., request removal or modification of the POI), and a single “Take Action” button may be provided that the subscriber may click on to initiate taking that course of action. Embodiments, however, are not so limited and the e-mail may include a “Take Action” button for each action available to the subscriber (e.g., no action, commentor communication, and litigation as a few examples). Furthermore, in an embodiment, the e-mail may suggest actions for the subscriber to take on its own such as offer a coupon or reply to the POI. In an embodiment, the e-mail to the subscriber may also include the name of the Web site (910) from where the POI was obtained and a link to a full review (912).

In an embodiment where the subscriber elects to request removal or modification of the POI, a request may be prepared, as is shown in step (512) of method (500). In an embodiment, the request may be automatically generated and sent to the hosting Web site, commentor, or both (step [512]). In an embodiment, however, the request may at least be initially auto generated such as by a form letter, for example, by detailing and/or capturing the annotated/marked POI similar to that which was sent to the subscriber but modified to be suitable for circulating to the hosting Web site (18). Alternatively, the request may identify/flag the POI and violating content as it appears on the hosting Web site (18) versus including the entire post/portion of the post in the request. Thereafter, the autogenerated form letter may be modified. For example, an autogenerated form letter may be modified as needed by an appropriate service partner. The service partner may also draft a letter from scratch or have its own form letters for distribution to hosting Web sites and/or commentors. An appropriate service partner, in an embodiment, may be a law firm that does not have a conflict of interest, such as by representing the commentor and/or the hosting Web site.

After the request is prepared and a decision has been made regarding where to send the request (hosting Web site, commentor, both) the request may then be sent (step [512]). With respect to hosting Web sites (18), most Web sites provide, within a page on the Web site, a dedicated e-mail address for communications regarding their various posts/content. Thus, the request may be submitted to the Web site's e-mail address, any other address that may be listed, or both. With respect to the commentor, the request may be sent to the commentor's contact information, if provided or easily discoverable.

If a particular hosting Web site has a relatively large volume of violating POIs over a given time (e.g., more than 10 in one day or a week), a consolidated report may be sent to the hosting Web site instead of, or in addition to, individual letters. Select (or all) hosting Web sites may be sent a consolidated report on a daily, weekly, or monthly basis. The consolidated report may identify new POIs that have been found to violate hosting Web site standards, provide confirmation that the hosting Web site has removed, or has requested that the commentor modify, previously identified POIs that violated Web site standards, and reminders that no action has been taken on previously identified violative POIs, as a few nonlimiting examples.

At step (514), embodiments of the system/method determines if the POI has been adequately modified by the commentor or has been taken down by the hosting Web site or commentor. If the POI has been adequately modified or taken down, the status of the POI may be changed to “done” and the case may be marked as “issue resolved,” “done,” or the like (step [516]) with no further action to be taken on behalf of the subscriber or the hosting Web site (18). If, however, the commentor has not adequately modified the POI or neither the hosting Web site nor the commentor has removed the POI, additional action may be taken, if any (step [518]).

In an embodiment, if the offending POI has not been removed, the subscriber may be consulted regarding taking a subsequent action (518). Subsequent actions may include, without limitation, ignoring the POI and abandoning the case or continuing to seek modification/removal of the POI. For example, if the commentor was not previously notified, the next action may be to determine the identity and/or contact information of the commentor. Such determination may include searching publicly available information on social media platforms, the hosting Web site platform, or the like (without limitation). In an embodiment, the system/method may contact the hosting Web site (18) to obtain the commentor's contact information.

After the commentor's information is identified, the subscriber may elect to send a communication to the commentor. Alternatively, if the commentor has been previously contacted, a subsequent request may be sent to the commentor. In either instance, the subscriber may indicate if the subscriber would like the tone of the communication to be congenial or confrontational. The goal of a congenial communication may be to offer a public relations solution or other solution that is mutually acceptable to the subscriber and the commentor. If public relations are not a concern or has already been attempted without success, the subscriber may wish to escalate by sending a “confrontational” communication such as a letter outlining the legal ramifications of the failure to modify/remove the POI and evidence of the consequences for failing to comply with the subscriber's request. The system/method may then determine if the additional action satisfied the subscriber in the resolution of any outstanding issues (step [514]). If yes, the case may be closed and marked as “finished” (step [516]). If not, then the subscriber may determine if additional actions are warranted (518). For example, the subscriber may elect to now abandon its pursuit or to proceed with steps toward litigation.

Therefore, as detailed, the specification identifies several embodiments of systems and processes for managing comments posted in an online forum, specifically those where there is risk of the veracity or authenticity of a post as it relates to a business. The systems, methods, and processes detailed herein, create an automated or semiautomated system, including scoring and other steps to seek out, identify, and remedy such violative posts.

It will be appreciated that the embodiments and illustrations described herein are provided by way of example, and that the present invention is not limited to what has been particularly disclosed. Rather, the scope of the present invention includes both combinations and subcombinations of the various feature described above, as well as variations and modifications thereof that would occur to persons skilled in the art upon reading the forgoing description and that are not disclosed in the prior art.

What is claimed is:

1. A system for evaluating a post of interest found on a Web site comprising:
a. a computer having a processor and a memory;
b. a database operatively connected to the computer, the database containing subscriber information and search terms relating to standards from the Web site; and
c. wherein the memory of the computer stores executable code which, when executed, enables the computer to perform a process comprising the following steps:
i. process the post of interest against the search terms, the post of interest obtained from the Web site and relating to a subscriber;
ii. mark content in the post of interest that corresponds to matched search terms, the marked content indicative of a violation of at least one Web site standard; and
iii. based on a result of the marking, recommend a solution to resolve the violation of the at least one Web site standard.

2. The system of claim 1 wherein a plurality of categories is identified from the standards for the Web site and the search terms are grouped so that each category in the plurality is associated with a corresponding group of search terms, the database containing the Web site's standards, the plurality of categories, and their corresponding group of search terms.

3. The system of claim 2 further comprising the step of updating the database to include newly identified search terms learned from the post of interest, the newly identified search terms grouped to be associated with a corresponding category in the plurality of categories.

4. The system of claim 2 further comprising the step of calculating a score for the post of interest, the score to reflect a number of standards violations for each category in the plurality of categories in which a violation was found.

5. The system of claim 4 wherein the database further contains conditions for authenticating the post of interest selected from the group consisting of: determining if a commentor photo is present in a commentor profile, determining if a commentor has posted at least one other comment on the Web site, determining if there is a positive statement in the posted comment relating to a competitor of the subscriber, determining if the commentor is using a fake name or an alias, and combinations thereof; and further comprising the step of calculating a degree to which the post of interest is authentic based on the determinations of the conditions.

6. The system of claim 2 wherein the step of marking content in the post of interest further comprises assigning a distinctive mark to each category in the plurality of categories to visually mark content in the post of interest according to category.

7. The system of claim 1 further comprising the step of enabling the subscriber to authorize acting on the recommended solution by generating a digital document that includes a selectable authorization button.

8. The system of claim 7 further comprising, in response to receiving an indication that the subscriber selected the selectable authorization button, automatically generating a communication to send to the Web site, a commentor, or both.

9. The system of claim 8 wherein automatically generating the communication further comprises identifying a particular standard from the Web site that was violated and the marked content in the post of interest that is in violation of the identified standard and requesting removal or modification of the post of interest.

10. A method for evaluating a comment posted on a Web site comprising:
a. extracting evaluation categories and associated search terms from standards obtained from the Web site;
b. using the associated search terms to identify and mark content in the comment that corresponds with at least one evaluation category; and
c. based on identification and marking results, recommending a course of action to take to resolve an issue relating to the Web site's standards.

11. The method of claim 10 further comprising generating a correspondence for a target of the comment, the correspondence to include a color-coded icon of a face with an expression and a range of stars from zero to five, the correspondence to also include a selectable button that, if selected, causes a letter to the Web site to be generated.

12. A method of scoring a post on a hosting Web site comprising:
a. identifying a post relating to a subscriber on the hosting Web site;
b. capturing a set of standards for the hosting Web site within a first database to construct a set of categories related to standards, each category having its own set of search terms;
c. copying the post and associated metadata into a second database;
d. grading the post against the set of categories to detect violations of the standards; and
e. circulating a report to the subscriber regarding the graded post, the report to include a recommended step forward based on the graded post results.

13. The method of claim 12 wherein grading against the set of categories comprises comparing the post to the set of search terms for each category and annotating the post to visually identify each of the violations wherein a violation of one category is marked with a different identifier than a violation of a different category.

14. The method of claim 12 further comprising the step of:
f. sending a periodic report to the hosting Web site, the periodic report to identify for removal one or more new posts that violate a standard since a last periodic report and to notify the hosting Web site of any updates regarding posts identified for removal in a previously sent report.

15. The method of claim 12 further comprising the steps of:
g. constructing a set of criteria based on the captured set of standards, the set of criteria related to positive or negative language, authenticity, or both, each criteria having its own set of search terms, identifier other than a search term, or both; and
h. grading the post against at least one criterion in the set of criteria.

16. The method of claim 15 wherein grading the post against at least one criterion further comprises using an algorithm to grade the post for authenticity, the algorithm to provide a probability relating to the authenticity of the post.

17. The method of claim 15 further comprising the step of:
i. grading the post for removal from the hosting Web site or for modification; and recommending communicating with the hosting Web site, the commentor, or both.

18. The method of claim 17 wherein each grading step comprises a score of between 0 and 10, and wherein a score of more than 0 indicates that the post violates of at least one category or criteria.

19. A method of determining accuracy of posted comments comprising the steps of:
a. copying posted comments to a database;
b. populating the database with standards relating to a location in which the posted comments were posted;
c. identifying violations of the standards by comparing the posted comments to the standards; and
d. annotating the violations to identify content in the posted comments by a particular standard of which the content is in violation.

20. The method of claim 19 wherein the annotating step (d) comprises highlighting content in different colors to correlate violative content to the particular standard of which the content is in violation.

21. The method of claim 19 wherein in step (b), the location is a hosting Web site, and wherein the standards comprise (i) terms of service or policies of the hosting Web site and (ii) laws and regulations based on the location of an IP address corresponding to the location of a commentor or of the hosting Web site.

22. The method of claim 21 further comprising the step of:
e. sending a report to an e-mail address listed on the hosting Web site for violations of the hosting Web site's terms of service, policies, or both.

23. The method of claim 19 wherein posted comments are selected from the group consisting of: text, video, a GIF, an image, and combinations thereof.
